(19) United States
(12) Patent Application Publication
(10) Pub. No.: US 2022/0243460 A1
(43) Pub. Date: Aug. 4, 2022

(54) BELOW GRADE, BLIND SIDE, WATERPROOFING SHEET MEMBRANE WITH ADHESIVE AND QUARTZERAL GRANULAR PARTICLE LAYER TO FULLY BOND TO CONCRETE/SHOTCRETE, AND A METHOD OF MAKING, AND USING SAME

(71) Applicant: Amir Rudyan, Canoga Park, CA (US)

(72) Inventors: Amir Rudyan, Agoura Hills, CA (US); Paul Thomas Miller, Valencia, CA (US)

(73) Assignee: Amir Rudyan, Canoga Park, CA (US)

(21) Appl. No.: 17/165,873

(22) Filed: Feb. 2, 2021

(51) Int. Cl. E04B 1/66; B32B 7/12; B32B 19/04

(52) U.S. Cl. CPC E04B 1/665; B32B 7/12; B32B 2307/7265; B32B 2419/00; B32B 2264/102; B32B 19/045

(57) ABSTRACT

The invention relates to a below grade, blind side, waterproofing sheet membrane with adhesive and quartzeral granular particle layer, and having a top release liner, and a bottom release liner, enhancing bond strength between sheets, and be able to fully bond to concrete/shotcrete, and a method of making, and using same. The inventive waterproofing sheet membrane with adhesive, has at least one layer of quartzeral granular particle layer that are fully or partly embedded into the adhesive layer, and where the average reflectivity of the exposed granular particles is between about 30 percent to 80 percent reflectivity on a standard reflectivity scale. The quartzeral sand or granular particles are hydrophobic, and any moisture or water can be easily removed from its surface. Even a wet quartzeral surface allows an adhesion or bonding of an adhesive to the quartzeral surface.

### FIELD OF THE INVENTION

The present invention relates generally to a below grade, blind side, waterproofing sheet membrane with adhesive and quartzeral granular particle layer, and having a top liner along one top edge, and a bottom liner along the opposite bottom edge, to fully bond to concrete/shotcrete, and a method of making, and using same. More particularly, the invention encompasses a below grade, blind side, waterproofing sheet membrane with adhesive, and having at least one layer of quartzeral granular particle layer that are fully or partly embedded into the adhesive layer, and where the average reflectivity of the exposed granular particles is between about 30 percent to about 80 percent reflectivity on a standard reflectivity scale. The waterproofing sheet membrane has an adhesive layer having embedded therein quartzeral granular particles is used in any building or wall construction, and can be placed under or around a foundation of a building or on its below grade blind side retaining walls, etc. The innovative quartzeral granular particle layer system that is securely bonded to concrete or shotcrete can be used along a wall, a floor, a ceiling, or along any structure which requires water or moisture proofing. The invention can be most effectively used between a concrete or shotcrete layer and the surrounding earth, such as, along an area that has a high-water table, or a constant hydrostatic pressure, or high ground moisture, that may creep into a foundation or a wall.

### BACKGROUND INFORMATION

Water or moisture penetration into a structure has have been known in the water proofing industry for many years, and the water proofing industry has addressed this well-known problem in a variety of ways, and which are well known to the people skilled in the art.

U.S. Pat. No. 8,453,405, to Robert A. Wiercisnki, et al., the disclosure of which is incorporated herein by reference discloses a waterproofing membrane that bonds to concrete cast against it (i.e., post-cast concrete). The membrane includes a flexible carrier sheet, a pressure sensitive adhesive and reflective particles on the surface of the adhesive. The reflective particles should have an average diameter equal to or greater than the thickness of the pressure sensitive adhesive. Preferably, the reflective particles are ground white cement, ground hydrated white cement, ground partially-hydrated white cement or a mixture of two or more of these. The membrane does not have a removable release sheet that is typically used to prevent the adhesive portion of the membrane from adhering to the carrier sheet or other portion of the membrane when the membrane is rolled up.

U.S. Pat. No. 8,713,879, to Robert A. Wiercisnki, et al., the disclosure of which is incorporated herein by reference discloses a waterproofing membrane that bonds to concrete cast against it (i.e., post-cast concrete). The membrane includes a flexible carrier sheet, a pressure sensitive adhesive, and reflective particles on the surface of the adhesive. The reflective particles should have an average diameter equal to or greater than the thickness of the pressure sensitive adhesive. Preferably, the reflective particles are ground white cement or ground white hydrated cement. The membrane does not have a removable release sheet that is typically used to prevent the adhesive portion of the membrane from adhering to the carrier sheet or other portion of the membrane when the membrane is rolled up.

U.S. Pat. No. 8,793,862 to Ulrich K. Weber, et al., the disclosure of which is incorporated herein by reference discloses a sealant which is arranged in a meshlike manner between a composite layer and a barrier layer in a water-tight membrane that includes a barrier layer and a composite layer. In the case of a leak in the barrier layer, the network of sealant between the composite layer and the barrier layer prevents the barrier layer from being affected. As a result, the size of the areas affected by penetrating water is limited. The damage by the penetrating water is thus limited to a smaller area, and the point of damage can thus be more easily localized.

U.S. Pat. No. 10,655,322, to Huhe Chen, et al., the disclosure of which is incorporated herein by reference discloses a waterproofing membrane which does not require a removable release sheet but which nevertheless bonds to post-cast concrete and facilitates water-tight sealing at membrane-to-membrane overlaps. The waterproofing membrane comprises a carrier and pressure-sensitive adhesive (PSA) layers, an inorganic particle layer having particulate bodies which are partially embedded in the PSA and which have an average particle size less than the average thickness of the PSA layer, and an anti-submarining nano-silica-containing coating layer attached to un-embedded portions of the inorganic particles to prevent total embedding into the PSA when the membrane is rolled or unrolled, whereby water-tight seams are facilitated between overlapped portions of adjacently installed waterproofing membranes, and whereby the water-tight seam is achieved preferably using only detailing or waterproofing tape and without the additional use of a liquid primer, mastic, or other coating.

However, this invention improves on the deficiencies of the prior art and provides an inventive below grade, blind side, waterproofing sheet membrane with adhesive and quartzeral granular particle layer to fully bond to concrete/shotcrete, and a method of making, and using same.

### PURPOSES AND SUMMARY OF THE INVENTION

The invention is a novel below grade, blind side, waterproofing sheet membrane with adhesive and quartzeral granular particle layer to fully bond to concrete/shotcrete, and a method of making, and using same.

Therefore, one purpose of this invention is to provide an inventive waterproofing layer having a waterproofing sheet membrane, and having an adhesive layer having quartzeral granular particles embedded therein.

Another purpose of this invention is to provide a novel below grade, blind side, waterproofing sheet membrane with adhesive and quartzeral granular particle layer to fully bond to concrete/shotcrete, and a method of making, and using same, and wherein reflectivity of the at least one layer of at least one quartzeral granular particle layer is between about 30 percent reflectivity to about 80 percent reflectivity.

Yet another purpose of this invention is to provide a novel below grade, blind side, waterproofing sheet membrane with adhesive and quartzeral granular particle layer to fully bond to concrete/shotcrete, and a method of making, and using same, and wherein the inventive waterproofing layer having a waterproofing sheet membrane, has at least one adhesive layer having quartzeral granular particles embedded therein, and having at least one release liner or sheet protecting at least a portion of the at least one adhesive layer.

Still yet another purpose of this invention is to provide a novel below grade, blind side, waterproofing sheet membrane with adhesive and quartzeral granular particle layer to fully bond to concrete/shotcrete, and a method of making, and using same, and wherein the inventive waterproofing layer having a waterproofing sheet membrane, has at least one adhesive layer having quartzeral granular particles embedded therein, and having a dual release liner or sheet protecting at least a portion of a first adhesive layer, and at least a portion of a second adhesive layer, and where a first release liner or sheet protects the first adhesive layer which is on the first or top or upper portion of the inventive waterproofing layer having a waterproofing sheet membrane, having the adhesive layer having embedded therein quartzeral granular particles, and a second release liner or sheet protects the second adhesive layer which is on the second or bottom or lower portion of the inventive waterproofing layer having a waterproofing sheet membrane, wherein the first release liner is along a first edge of the inventive waterproofing layer, and the second release liner is along a second edge of the inventive waterproofing layer, and wherein the first release liner and the second release liner are at the opposite edges of the inventive waterproofing layer, and also on the opposite sides.

Still yet another purpose of this invention is to provide at least one waterproof bather layer having quartzeral granular particles embedded therein via at least one adhesive to form a bond with a concrete or shotcrete layer.

Therefore, in one aspect this invention comprises a method of making a below grade, blind side, waterproofing sheet membrane with adhesive and quartzeral granular particle layer to fully bond to concrete/shotcrete, comprising the steps of:

(a) forming a sheet having a first surface and a second surface;
(b) moving said sheet to at least one charging station, and applying a charge to said first surface and said second surface of said sheet using at least one ground wire along said first surface of said sheet, and at least one high voltage wire along said second surface of said sheet to form a charged sheet;
(c) moving said charged sheet to at least one adhesive station, and applying at least one first adhesive layer along said first surface of said sheet, and applying at least one second adhesive layer along at least a portion of said second surface of said sheet, to form a sheet with at least one adhesive layer;
(d) moving said sheet with at least one adhesive layer to at least one particle application station, and applying at least one layer of at least one quartzeral granular particle layer along at least a portion of said at least one first adhesive layer, to form a waterproofing sheet membrane having at least one adhesive layer, and having at least one quartzeral granular particle layer.

In another aspect this invention comprises a below grade, blind side, waterproofing sheet membrane with adhesive and quartzeral granular particle layer to fully bond to concrete/shotcrete, comprising:

(a) at least one sheet membrane having a first membrane surface, and a second membrane surface;
(b) at least one first adhesive layer having a first adhesive surface, and a second adhesive surface, and wherein said second adhesive surface is in secure contact with at least a portion of said first membrane surface; and
(c) at least one layer of at least one quartzeral granular particle layer, having a first particle layer surface, and a second particle layer surface, and wherein said second particle layer surface is in secure contact with at least a portion of said first adhesive surface, and wherein reflectivity of said at least one layer of at least one quartzeral granular particle layer is between about 30 percent reflectivity, to about 80 percent reflectivity.

In yet another aspect this invention comprises a method of forming a below grade, blind side, waterproofing sheet membrane with adhesive and quartzeral granular particle layer to fully bond to concrete/shotcrete, comprising the steps of:

(a) taking at least one sheet membrane having a first membrane surface, and a second membrane surface;
(b) applying at least one first adhesive layer having a first adhesive surface, and a second adhesive surface, onto said at least one sheet membrane, and wherein said second adhesive surface is in secure contact with at least a portion of said first membrane surface; and
(c) applying at least one layer of at least one quartzeral granular particle layer, having a first particle layer surface, and a second particle layer surface, over at least a portion of said at least one first adhesive layer, and wherein said second particle layer surface is in secure contact with at least a portion of said first adhesive surface, and wherein reflectivity of said at least one layer of at least one quartzeral granular particle layer is between about 30 percent reflectivity, to about 80 percent reflectivity.

In still yet another aspect this invention comprises a granular material, comprising: quartzeral, and wherein said quartzeral consists essentially of particles of calcite in a form of calcium carbonate, and made from crushed, fine-grained marble.

In yet another aspect this invention comprises a waterproofing membrane assembly system for a building, comprising:

(a) at least one soil retention system having a first face and a second face, and wherein said first face faces compacted earth or soil;
(b) at least one first waterproof membrane having a first face and a second face, and wherein at least a portion of said first face of said at least one first waterproof membrane is secured to at least a portion of said second face of said at least one soil retention system, and said at least one first waterproof membrane is composed of a layer of a first material;
(c) at least one second waterproof membrane having a first face and a second face, said at least one second waterproof membrane defining at least one waterproof skin membrane comprising at least one layer of quartzeral material, and wherein at least a portion of said first face of said at least one waterproof skin membrane is secured to at least a portion of said second face of said at least one first waterproof membrane, and wherein said at least one layer of quartzeral material is on said second face of said at least one waterproof skin membrane, so as to form a dual waterproofing membrane assembly system for said building.

### BRIEF DESCRIPTION OF THE DRAWINGS

FIG. 1, illustrates a first embodiment of the inventive below grade, blind side, waterproofing sheet membrane with adhesive and quartzeral granular particle layer to fully bond to concrete/shotcrete.

FIG. 2, illustrates a second embodiment of the inventive below grade, blind side, waterproofing sheet membrane with adhesive and quartzeral granular particle layer to fully bond to concrete/shotcrete.

FIG. 3, illustrates a third embodiment of the inventive below grade, blind side, waterproofing sheet membrane with adhesive and quartzeral granular particle layer to fully bond to concrete/shotcrete.

FIG. 4, illustrates a fourth embodiment of the inventive below grade, blind side, waterproofing sheet membrane with adhesive and quartzeral granular particle layer to fully bond to concrete/shotcrete.

FIG. 5, illustrates a fifth embodiment of the inventive below grade, blind side, waterproofing sheet membrane with adhesive and quartzeral granular particle layer to fully bond to concrete/shotcrete.

FIG. 6, illustrates a sixth embodiment of the inventive below grade, blind side, waterproofing sheet membrane with adhesive and quartzeral granular particle layer to fully bond to concrete/shotcrete.

FIG. 7, illustrates a seventh embodiment of the inventive below grade, blind side, waterproofing sheet membrane with adhesive and quartzeral granular particle layer to fully bond to concrete/shotcrete.

FIG. 8, illustrates an eight embodiment of the inventive below grade, blind side, waterproofing sheet membrane with adhesive and quartzeral granular particle layer to fully bond to concrete/shotcrete.

FIG. 9, illustrates a ninth embodiment of the inventive below grade, blind side, waterproofing sheet membrane with adhesive and quartzeral granular particle layer to fully bond to concrete/shotcrete.

FIG. 10, illustrates a tenth embodiment of the inventive below grade, blind side, waterproofing sheet membrane with adhesive and quartzeral granular particle layer to fully bond to concrete/shotcrete.

FIG. 11, illustrates an eleventh embodiment of the inventive below grade, blind side, waterproofing sheet membrane with adhesive and quartzeral granular particle layer to fully bond to concrete/shotcrete.

FIG. 12, illustrates a twelfth embodiment of the inventive below grade, blind side, waterproofing sheet membrane with adhesive and quartzeral granular particle layer to fully bond to concrete/shotcrete.

FIG. 13, illustrates a thirteenth embodiment of the inventive below grade, blind side, waterproofing sheet membrane with adhesive and quartzeral granular particle layer to fully bond to concrete/shotcrete.

### DETAILED DESCRIPTION

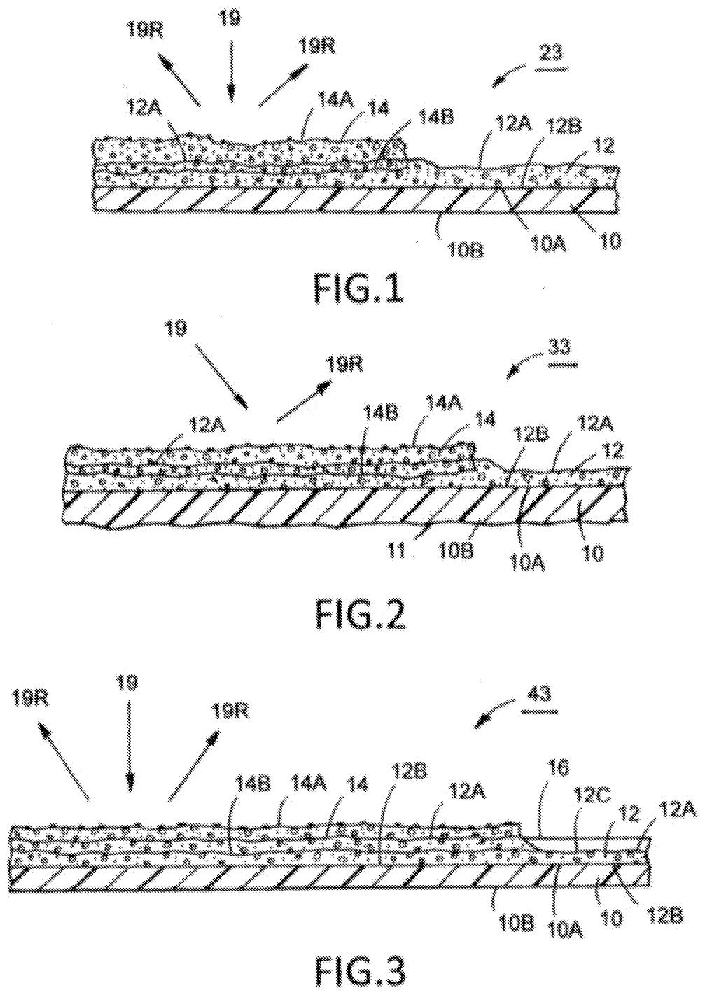

The inventive below grade, blind side, waterproofing sheet membrane with adhesive and quartzeral granular particle layer to fully bond to concrete/shotcrete, and a method of making, and using same will now be discussed with reference to FIGS. 1 through 13. Although the scope of the present invention is much broader than any particular embodiment, a detailed description of the preferred embodiment follows together with drawings. These drawings are for illustration purposes only and are not drawn to scale. Like numbers represent like features and components in the drawings.

In summary the invention is a below grade, blind side, waterproofing sheet membrane with adhesive and quartzeral granular particle layer to fully bond to concrete/shotcrete, and a method of making, and using same in a building or wall construction, and placing it under and around a foundation of a building or dwelling or on its below grade blind side retaining walls, etc.

It should be appreciated that the quartzeral is a non-cement based granule. It should be further appreciated that one of the problems with cement-based particles is that they absorb and retain water. Therefore, once the cement-based particles get wet, even if the water/moisture is wiped off the surfaces with a dry cloth, the cement particles remain water-logged, making it impossible for an adhesive, such as, a double-sided adhesive tape to bond to or be secured to the cement based sand or granular surface. This problem of surface adhesion of an adhesive tape over a granular surface has been overcome by the use of quartzeral. It has been discovered that the quartzeral sand or granular particles do not absorb much water, thus allowing an adhesive tape, such as, for example, a double-sided adhesive tape to bond better to the quartzeral sand or granular surfaces even when wet. In some applications one can easily wipe away any surface water or moisture that maybe on the quartzeral surface without the need to dry the quartzeral surface, (like one would have to do if the granules were cement or cement based) and then be able to secure an adhesive, such as, a double-sided adhesive tape to it. This eliminates installation delays commonly experienced with similar systems that incorporate cement-based granules since it eliminates the need to dry the cement particles or wait for the cement particles to dry on their own before applying, for example an adhesive, such as, a double-sided tape with an adhesive, or the need to remove the cement based granules altogether, before for example, applying an adhesive, such as, a double sided tape with an adhesive. Working with similar systems that have cement based granules could become a major issue in wet weather or when there is formation of dew, etc., on the surfaces of the cement-based granules.

It should be appreciated that another problem with cement-base particles is that they are inherently dusty. This means that even when dry it can be difficult to adhere any adhesive tape to the surface. Current cement-based particles require either complete removal of the cement-based granules or much physical effort to blow/sweep the dust the cement based granules create off the membrane or sheet surface. If an adhesive tape does not adhere well to the surface of the joint then water or moisture may slip or creep through the joint, and enter the building. It has been discovered that quartzeral does not produce the same type of dust and thus provides a much better surface to adhere an adhesive tape in dry conditions. Additionally, the quartzeral surface does not require significant effort to cleanup prior to the placement of the double-sided adhesive tape. Furthermore, once cleaned the double-sided adhesive tape bonds more aggressively to the quartzeral than cement-based granules. This not only saves the applicator time in labor, but it also reduces the risk of water migrating through the seams of the inventive fully bonded membrane.

Quartzeral, a product sold by AVM Industries, Inc., 8245 Remmet Ave., Canoga Park, Calif. 91304, under the Trademark Aussie Sand™. Quartzeral, consists essentially of particles or grains of calcite, a form of calcium carbonate, and may be made from crushed, fine-grained marble. The crushed marble/calcite sand grains/particles may contain a trace or minor phase comprising quartz. Quartzeral could further include a coating of rutile, i.e., titanium dioxide, which may be applied as a pigment coating to the grains or particles of quartzeral to achieve lighter or darker colors, as desired by a user. Quartzeral, is substantially hydrophobic, and essentially does not absorb water, allowing any surface water to evaporate quickly. Additionally, quartzeral, allows a tape with an adhesive to adhere to its surface. Furthermore, wet quartzeral, allows a tape with an adhesive to adhere to its surface. Quartzeral currently has between about 40 percent, to about 43 percent, reflectivity, which could be increased, or decreased, such as, by adding at least one dye, or at least one complementary material. It should be appreciated that quartzeral is a non-cement material. Quartzeral in one aspect is described as granulated material comprised primarily of calcite and/or crushed, fine-grained marble for use as a component in sheet based waterproofing membranes for use in construction.

FIG. 1, illustrates a first embodiment of the inventive below grade, blind side, waterproofing sheet membrane with adhesive and quartzeral granular particle layer to fully bond to concrete/shotcrete 23, where the sheet membrane or layer 10, having a first or top or upper surface 10A, and a second or lower or bottom surface 10B, has secured thereto at least one layer of at least one first adhesive 12, such that the first adhesive layer 12, has a first or top or upper surface 12A, and a second or lower or bottom surface 12B, and wherein the first surface 10A, of the sheet membrane 10, is in secure contact with the second surface 12B, of the first adhesive layer 12. At least one layer of at least one quartzeral granular particle layer 14, having a first or top or upper surface 14A, and a second or lower or bottom surface 14B, is in secure contact with the first adhesive layer 12, such that the first surface 12A, of the first adhesive layer 12, is in secure contact with the second surface 14B, of the at least one quartzeral granular particle layer 14, and this combination forms the inventive waterproofing sheet membrane with adhesive and quartzeral granular particle layer 23. For some applications portions of the at least one quartzeral granular particle layer 14, could be partially or fully embedded within the at least one first adhesive layer 12. Similarly, for some applications the second surface 14B, of the at least one quartzeral granular particle layer 14, could be below the planar surface of the first surface 12A, of the at least one first adhesive layer 12. The sheet membrane 10, can be made from a material 10, selected from a group comprising a high-density polyethylene (HDPE) material, a thermoplastic polyolefin (TPO) material, and combinations thereof, to name a few. The thickness of the sheet membrane 10, is preferably between about 1.0 mm to about 2.5 mm. As shown in FIG. 1, incoming light 19, is reflected or disbursed as reflected light 19R. The at least one layer of at least one quartzeral granular particle layer 14, can be selected from a group consisting of quartzeral, particles or grains of calcite, a form of calcium carbonate, and may be made from crushed, fine-grained marble. The crushed marble/calcite sand grains may contain a trace/minor phase comprising quartz. A coating of rutile, i.e., titanium dioxide, may be applied as a pigment coating to the quartzeral grains to achieve lighter or darker colors, as desired by a user or manufacturer. Furthermore, quartzeral granular particles 14, can be tinted or dyed or at least one complementary material could be added to provide a lighter color or high reflectivity, or a darker color or low reflectivity, to the granular particle layer 14. The average reflectivity of the quartzeral granular particles 14, are between about 30 percent reflectivity, to about 80 percent reflectivity. For some applications the high reflectivity could be between say, about 60 percent reflectivity to say about 80 percent reflectivity, and preferably about 65 percent reflectivity. Similarly, for some applications the low reflectivity could be between say, about 30 percent reflectivity to say about 50 percent reflectivity, and preferably about 45 percent reflectivity. As one can appreciate that the quartzeral sand particles or the granules have both smooth surfaces, and jagged surfaces, which of course would affect the average reflectivity, and thus one needs to look at the average reflectivity over the surface of the quartzeral sand or granules layer. It should be understood that the average reflectivity test as used herein is an average reflectivity test that will be conducted over the surface of the inventive membrane sheet 23, having the at least one quartzeral granular particles 14, are over it, and it is possible that there may be some variance in the location reflectivity, which would depend on where the reflectivity test of the inventive sheet membrane 23, i.e., the first or top membrane sheet surface or layer 14A, might not be, for example, uniformly colored. Thus, it is possible that in production one could have lighter and darker spots or areas on the inventive sheet membrane 23, however, the average reflectivity of the top or upper surface 14A, should be, for example, between about 30 percent reflectivity, to about 80 percent reflectivity. For some applications the low reflectivity could be between say, about 35 percent to say about 55 percent. However, for some applications the reflectivity could be, for example, between about 30 percent reflectivity, to about 80 percent reflectivity, and more preferably say, above 45 percent reflectivity, to above 55 percent reflectivity. Another benefit of the inventive membrane sheet 23, having a high reflectivity is that by reflecting a large amount of light, it keeps the membrane 10, cooler. Still another advantage of this invention is that it helps to reduce the expansion, and contraction of the layer or membrane 10, such as, for example, a plastic sheet membrane 10, and especially, between the cold winter, and hot summer, extremes of the weather conditions. The angle of reflection depends on how the reflection 19R, is being measured, and thus the inventor has defined an average reflectivity range, and not the method or the instrument being used to observe the reflectivity of the quartzeral granular particle layer 14, on the surface 14A. It should be understood that the average reflectivity test as used herein is an average reflectivity test that will be conducted over the surface having the at least one quartzeral granular particle layer 14, on the surface 14A, of the inventive sheet membrane 23. It is possible that there may be some variance in the location reflectivity, which would depend on where the reflectivity test of the inventive sheet membrane 23, i.e., the first or top sheet surface or layer 14A, might not be, for example, uniformly covered with the quartzeral granular particles 14, and thus it is possible that in production one could have lighter and darker spots or regions on the inventive sheet membrane 23, however, the average reflectivity of the top or upper surface or layer 14A, should be, for example, between about 30 percent reflectivity, to about 80 percent reflectivity, and preferably between about 40 percent reflectivity, to about 70 percent reflectivity, and more preferably between about 550Q percent reflectivity, to about 60 percent reflectivity.

FIG. 2, illustrates a second embodiment of the inventive below grade, blind side, waterproofing sheet membrane with adhesive and quartzeral granular particle layer to frilly bond to concrete/shotcrete 33, which is similar to the first embodiment 23, but, wherein the second surface 10B, of the sheet membrane 10, is provided with a surface 11, and wherein the surface 10B, 11, can be selected from a group comprising, smooth surface, texture surface, light texture surface, embossed surface, lightly embossed surface, undulating surface, and combinations thereof, to name a few.

FIG. 3, illustrates a third embodiment of the inventive below grade, blind side, waterproofing sheet membrane with adhesive and quartzeral granular particle layer to fully bond to concrete/shotcrete 43, which is similar to the first embodiment 23, but, wherein a layer portion or edge portion 12C, of the first adhesive layer 12, does not have the at least one layer of at least one quartzeral granular particle layer 14, over the first surface 12A, and where the layer portion 12C, could be covered or protected with at least one first or top removable release layer or sheet 16, which release layer or sheet 16, is removed, as needed, during installation or application of the inventive waterproofing sheet membrane with adhesive and quartzeral granular particle layer 43. It is preferred that the layer portion 12C, is along at least one edge of the first adhesive layer 12, and preferably along a factory edge 12C, such as, a selvedge 12C.

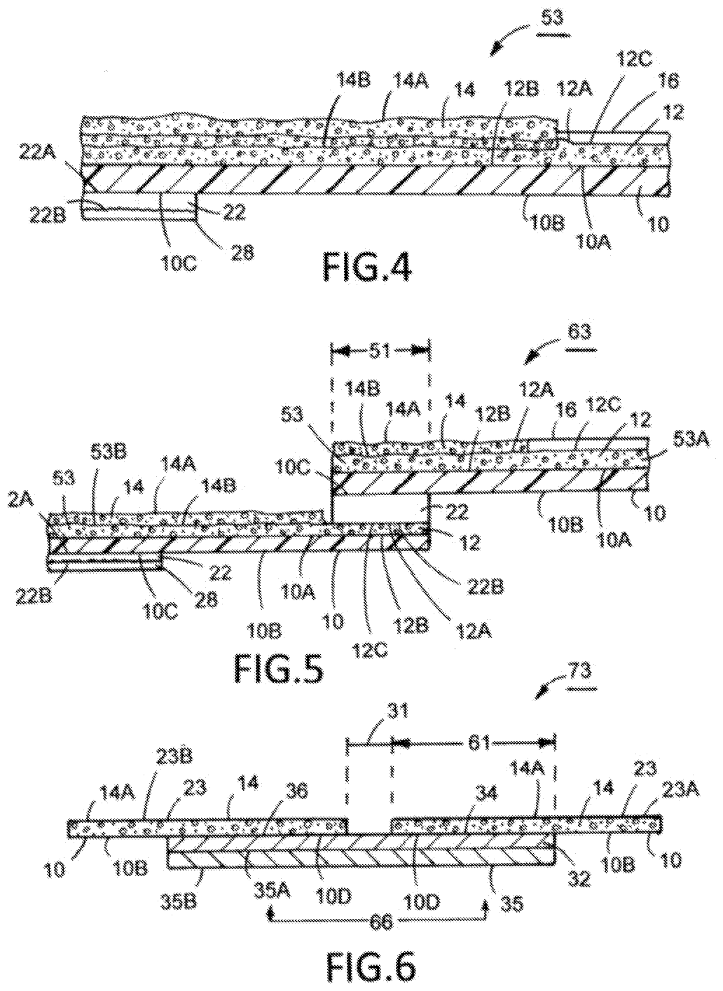

FIG. 4, illustrates a fourth embodiment of the inventive below grade, blind side, waterproofing sheet membrane with adhesive and quartzeral granular particle layer to fully bond to concrete/shotcrete 53, which is similar to the third embodiment 43, and wherein a layer portion or edge portion 10C, of the membrane 10, has secured thereto, at least one layer of at least one second adhesive layer 22, along a portion of the second surface 10B, in the layer portion or area 10C. The second adhesive layer 22, has a first or top or upper surface 22A, and a second or lower or bottom surface 22B. The second surface 22B, of the second adhesive layer 22, is preferably covered or protected with at least one second or bottom removable release layer or sheet 28, while the surface 22A, of the at least one second adhesive layer 22, is in secure mating contact with the second surface 10B, in the layer portion or area 10C. The at least one second release layer or sheet 28, is removed, as needed, during installation or application of the inventive waterproofing sheet membrane with adhesive and quartzeral granular particle layer 53. It is preferred that the layer portion 10C, is along at least one edge of the membrane layer 10, and preferably along a factory edge 10C, such as, a selvedge 10C.

As one can see in FIG. 4, that the inventive below grade, blind side, waterproofing sheet membrane with adhesive and quartzeral granular particle layer to fully bond to concrete/shotcrete 53, has a dual release liner 16, 28, comprising of a first or top or upper release liner 16, at one end or edge or portion 12C, of the inventive waterproofing sheet membrane with adhesive and quartzeral granular particle layer 53, and a second or bottom or lower release liner 28, at the opposite end or edge or portion 10C, of the inventive waterproofing sheet membrane with adhesive and quartzeral granular particle layer 53. This innovative configuration allows the inventive waterproofing sheet membrane with adhesive and quartzeral granular particle layer 53, to mate with other sheet membranes 53, so as to extend the length of the sheet membranes 53, by mating one to the other as more clearly shown in FIG. 5. It should also be appreciated that this innovative configuration allows the sheet membrane 53, to be installed in a moist or damp or water filled environment or under water, as the release layer 16, 28, can be removed in situ and the adhesive 12, 22, would adhere to the surface to which it is applied or mated or secured to. Thus, it should be appreciated that the adhesive 12, 22, protected by the release liner 16, 28, respectively, is a pressure sensitive adhesive (PSA) 12, 22, and would automatically adhere to the surface to which it is applied or mated to once the corresponding release liner 16, 28, is removed.

FIG. 4, also illustrates that the inventive waterproofing layer 53, having a waterproofing sheet membrane, having at least one adhesive layer having embedded therein quartzeral granular particles 53, has dual removable release liners or sheets 16, 28, protecting a first adhesive layer 12, and a second adhesive layer 22, respectively, and where the first removable release layer or sheet 16, protects the first adhesive layer 12, which is on the first or top or upper portion 12A, of the inventive waterproofing layer 53, having a waterproofing sheet membrane, having at least one adhesive layer having embedded therein quartzeral granular particles 53, and a second removable release layer or sheet 28, protects the second adhesive layer 22, which is on the second or bottom or lower portion 10B, of the inventive waterproofing layer 53, having a waterproofing sheet membrane, having at least one adhesive layer having embedded therein quartzeral granular particles 53.

FIG. 5, illustrates a fifth embodiment of the inventive below grade, blind side, waterproofing sheet membrane with adhesive and quartzeral granular particle layer to fully bond to concrete/shotcrete 63, which is similar to the fourth embodiment 53. As shown in FIG. 5, the two inventive sheets 53, comprises of a first inventive membrane sheet 53A, and a second inventive membrane sheet 53B, which are joined or mated together, so as to create a “continuous” or an extended inventive membrane sheet 53, 63. As shown in FIG. 5, one edge of the first inventive membrane sheet 53A, is secured to another edge of a second inventive membrane sheet 53B. As shown in FIG. 5, the top release layer or sheet 16, of the second inventive sheet 53B, is removed so as to expose at least a portion of the first adhesive layer 12, along the layer portion or edge portion 12C, and the bottom release sheet 28, of the first inventive membrane sheet 53A, is removed so as to expose at least a portion of the second surface 22B, of the second adhesive layer 22, along the layer portion or edge portion 10C, and wherein at least a portion of the first adhesive layer 12, of the second inventive sheet 53B, is secured to at least a portion of the second adhesive layer 22, of the first inventive membrane sheet 53A, and thus creating a bond along a length or area or overlap 51.

FIG. 6, illustrates a sixth embodiment of the inventive below grade, blind side, waterproofing sheet membrane with adhesive and quartzeral granular particle layer to fully bond to concrete/shotcrete 73, where one edge of a first inventive sheet membrane 23, is secured to another edge of a second inventive sheet membrane 23. A detail strip 35, having a first or upper or top surface 35A, and a second or lower or bottom surface 35B, is used to secure at least two inventive sheet membranes 23, along a seam or gap 31. As shown in FIG. 6, the two individual inventive sheet membrane 23, comprises of at least one first inventive sheet membrane 23A, and at least one second inventive sheet membrane 23B, that are joined or mated together along an edge or seam 31, so as to create a “continuous” or an extended inventive sheet membrane 23, 73. As shown in FIG. 6, a release layer or sheet (not shown) is removed from the upper surface 35A, of the detail strip 35, so as to expose at least one layer of at least one third adhesive layer 32, which has already been secured to an upper or top surface 35A, of the detail strip 35. The second surface 10B, of a first inventive sheet membrane 23A, is placed over a first adhesive portion 34, of the third adhesive layer 32, and the two surfaces are securely mated or joined each to the other creating a bond along a length or area or overlap 61. In the next step, the second surface 10B, of a second inventive sheet membrane 23B, is placed over a second adhesive portion 36, of the exposed portion of the third adhesive layer 32, and the two surfaces are securely mated or joined each to the other, similarly, creating a bond along a length or area or overlap 61. The sixth embodiment is very useful when installing the “alternative non-factory lap”. It should be appreciated that the edges of the inventive sheet membrane 23, may not be perfectly straight or aligned, and thus one could have a seam or gap 31, between the edges of the first inventive sheet membrane 23A, and the second inventive sheet membrane 23B. For some applications one could also use a pressure source 81, as shown in FIG. 8, such as, for example, using a steel or rubber roller over the seam or gap 31, several time while applying significant pressure to completely and securely bond or mate the detail strip 35, to the first inventive sheet membrane or layer 23A, and to the second inventive sheet membrane or layer 23B. For some applications it is preferred that a pressure source 81, such as, for example, a steel or rubber roller 81, is rolled or passed over the lap or the joint area or seam 66, several times while applying pressure 81, to ensure proper adhesion between the first at least one sheet membrane with adhesive layer 23A, and the second at least one sheet membrane with adhesive layer 23B, that are being joined at their respective edges. A similar pressure source 81, can also be used whenever a first inventive sheet or membrane 23A, is being mated or secured to a second inventive sheet or membrane 23B, such as, along an edge 10D, or selvedge 10D, 12C.

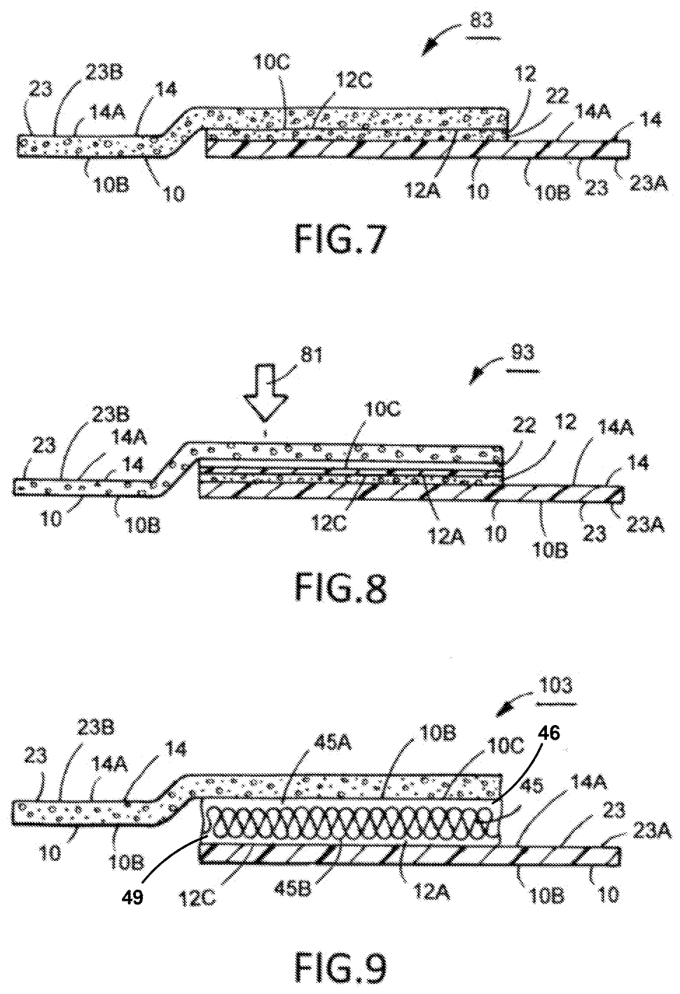

FIG. 7, illustrates a seventh embodiment of the inventive below grade, blind side, waterproofing sheet membrane with adhesive and quartzeral granular particle layer to fully bond to concrete/shotcrete 83, where one portion, such as, an edge 10C, 12C, of a first inventive sheet membrane 23, is secured to another portion, such as, an edge 10C, 12C, of a second inventive sheet membrane 23. As shown in FIG. 7, the two individual inventive sheet membranes 23, comprises of at least one first inventive sheet membrane 23A, and at least one second inventive sheet membrane 23B, that are joined or mated together along an edge so as to create a “continuous” or an extended inventive sheet membrane 23, 83. As shown in FIG. 7, the layer portion 12C, of the first surface 12A, of the first adhesive layer 12, of the first inventive sheet membrane 23A, is exposed for securing to the second inventive sheet membrane 23B, or the second adhesive layer 22, along the surface 10B, or layer portion 10C, of the second inventive sheet membrane 23B, is exposed for securing to the second inventive sheet membrane 23B. Thus, one would take the exposed surface of the first adhesive layer 12, or the second adhesive layer 22, of the first inventive sheet membrane 23A, and secure it to a portion of the second inventive sheet membrane 23B, that does not have an exposed first adhesive layer 12, or second adhesive layer 22, such as, along an edge 10C, 12C, or selvedge 10C, 12C.

FIG. 8, illustrates an eight embodiment of the inventive below grade, blind side, waterproofing sheet membrane with adhesive and quartzeral granular particle layer to fully bond to concrete/shotcrete 93, where one portion, such as, an edge 10C, 12C, of a first inventive sheet membrane 23, is secured to another portion, such as, an edge 10C, 12C, of a second inventive sheet membrane 23. As shown in FIG. 8, the two individual inventive sheet membranes 23, comprises of at least one first inventive sheet membrane 23A, and at least one second inventive sheet membrane 23B, that are joined or mated together along an edge so as to create a “continuous” or an extended inventive sheet membrane 23, 93. As shown in FIG. 8, the layer portion 12C, of the first surface 12A, of the first adhesive layer 12, of a first inventive sheet membrane 23A, has the first adhesive surface 12A, exposed, such as, by the removal of the release sheet 16, and that the second inventive sheet membrane 23B, having the second adhesive layer 22, is also exposed, such as, by the removal of the release sheet 28, and thus the exposed surface of the first adhesive layer 12, is mated with and secured to the exposed surface of the second adhesive layer 22, which results in the joining of the first inventive sheet membrane 23A, to the second inventive sheet membrane 23B, such as, along an edge 10C, 12C, or selvedge 10C, 12C. Optionally, one could also use at least one pressure source 81, such as, for example, a steel or rubber roller 81, that could be applied over the seam or gap 31, or the overlap 51, 61, several times while applying significant pressure to completely, and securely bond the first inventive sheet membrane 23A, to the second inventive sheet membrane 23B. At least one pressure source 81, can also be used whenever a first inventive sheet or membrane 23A, is being mated or secured to a second inventive sheet or membrane 23B, such as, along an edge 10D, or selvedge 10D. For some applications, such as, for example, during cold or wet weather where a first at least one inventive sheet membrane 23A, for some reason is not adhering to a second at least one inventive sheet membrane 23B, one could optionally, and gently, use at least one securing force 81, such as, for example, a heat gun 81, or a welder 81, (such as, a Liester welder), which would help improve the adhesion between the two overlapping inventive sheet membranes 23A, and 23B, such as, for example, along the overlap 51, 61. Thus, it should be understood that the at least one securing force 81, could be selected from a group comprising a roller, steel roller, a rubber roller, a plastic roller, a heat gun, a welder, and combinations thereof, to name a few.

FIG. 9, illustrates a ninth embodiment of the inventive below grade, blind side, waterproofing sheet membrane with adhesive and quartzeral granular particle layer to fully bond to concrete/shotcrete 103, where one portion, such as, an edge 10C, 12C, of a first inventive sheet membrane 23, is secured to another portion, such as, an edge 10C, 12C, of a second inventive sheet membrane 23. As shown in FIG. 9, the two individual inventive sheet membranes 23, comprises of at least one first inventive sheet membrane 23A, and at least one second inventive sheet membrane 23B, that are joined or mated together along an edge so as to create a “continuous” or an extended inventive sheet membrane 23, 103. As shown in FIG. 9, the first surface 12A, or the first surface 14A, of the first inventive sheet membrane 23A, has secured thereto at least one double sided adhesive tape 45, such as, for example, an Aussie Skin Double Sided adhesive tape 45. The at least one double-sided adhesive tape 45, has a first or upper or top surface 45A, having at least one first adhesive layer or film 46, and a second or lower or bottom surface 45B, having at least one second adhesive layer or film 49. The second surface 10B, of the second inventive sheet membrane 23B, is placed over at least an exposed portion of the double-sided adhesive tape 45, and the two inventive sheet membranes 23A, and 23B, are mated or joined each to the other via the first adhesive layer 46, and the second adhesive layer 49, and which results in the joining of the first inventive sheet membrane 23A, to the second inventive sheet membrane 23B, such as, along an edge 10C, 12C, or selvedge 10C, 12C, using the double-sided adhesive tape 45, and creating an overlap 51, 61.

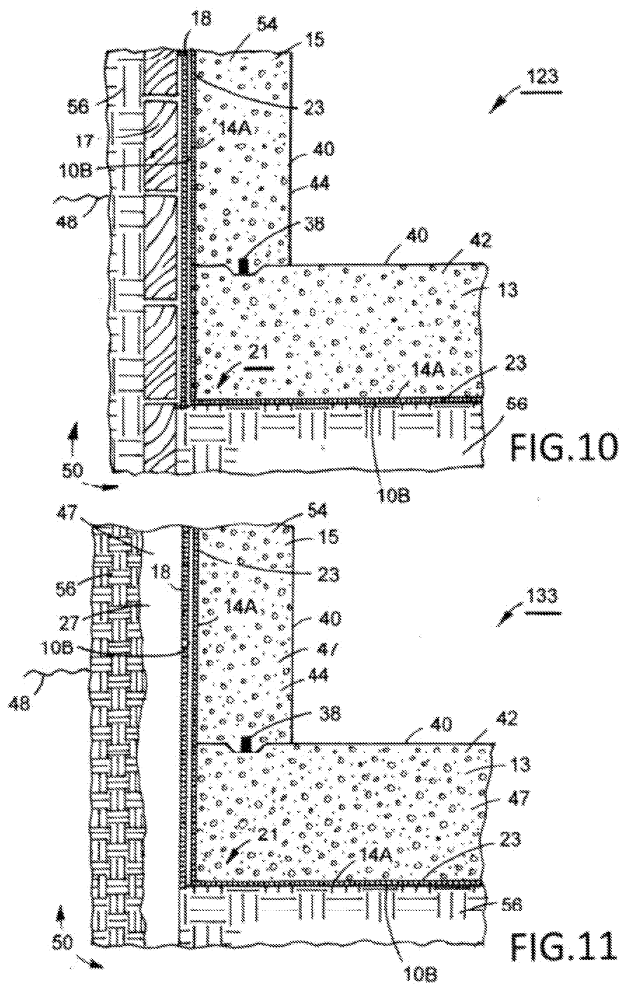

FIG. 10, illustrates a tenth embodiment of the inventive below grade, blind side, waterproofing sheet membrane with adhesive and quartzeral granular particle layer to fully bond to concrete/shotcrete 123. After an area 50, has been dug up or prepared for the foundation of a building 54, or a concrete floor surface 42, or a concrete wall surface 44, or a structure 54, it is recommended that the area under the floor areas 42, be either compacted, to form a compacted earth 56, or that a mud slab 56, be installed, so as to create a substantially flat horizontal or floor surface 42. It is also recommended that similar steps are also taken for the preparation of a side wall surface 44, or a blind wall surface 44, or a similar other structure 54, where the earth around the area 50, is compacted so as to create compacted or retained earth 56, or a mud slab 56, creating a substantially flat vertical or wall surface 44. For some applications it is recommended that at least one layer of a retaining means 17, or a soil retention system 17, such as, for example, wood lagging 17, be installed along the exposed surface or face of the compacted or retained earth 56, or the mud slab 56. For a blind side wall surface 44, a soil retention system 17, could also be installed, such as, for example, using wood lagging 17, soil cement 17, etc. It should be appreciated that a soil retention system 17, helps in holding back the compacted earth or dirt 56, from coming down due to, for example, gravity. The soil retention system 17, also helps in creating a substantially uniform vertical wall surface 44, for the concrete wall 15. Optionally, for some applications, if needed, one could also place at least one drain board 18, (such as, for example, AVM Drain Board 6000), or at least one foam layer 18, or at least one polystyrene insulation board 18, or any other protection media 18, as required, along the exposed surface or face of the wood lagging 17. The next step is to apply or secure at least one layer of the inventive membrane sheet 23, such as, for example, Aussie Skin 550Q, Aussie Skin 560Q, against the open face or wall surface of the retaining means 17, or drain board 18, or foam layer 18, (if used) or over or against the compacted earth 56, or mud slab 56, or waist slab 56, or the soil retention system 17. It should be understood that the second surface 10B, of the sheet membrane or layer 10, would be secured to the open face of the wood lagging 17, or drain board 18, or foam layer 18, (if used) or over or against the compacted earth 56, or mud slab 56, or waist slab 56, or the soil retention system 17, and the first surface 14A, of the at least one layer of at least one quartzeral granular particle layer 14, would be used to secure or apply the concrete/shotcrete 13, 15. The inventive sheet waterproofing membrane or layer 23, usually comes in sheets 23, or rolls 23, which are then hung onto the exposed face of the wood lagging 17, or drain board 18, or foam layer 18, (if used), using at least one securing means, such as, nails, screws, bolt, anchor, adhesive material, and combinations thereof, to name a few. The inventive sheet waterproofing layer 23, that is installed along the surface of the wall 15, may terminate at the wall-to-floor corner 21, or be returned or extend several inches along the floor 13, such as, for example, say about 12 inches along the floor 13, and creating at least one sheet waterproofing layer extension, or for some applications it could extend along the whole floor surface or floor 13. The inventive membrane or layer 23, may not need to be secured to the floor 13, at all and simply be laid on the ground or floor 13, and then one would use gravity to hold the layer or sheet membrane 23, in place. For most applications the floor 13, is cast first, and then the stem wall 44, is cast next. In addition, generally if the floor 13, requires waterproofing then the inventive membrane 23, is installed horizontally first, and extended up to the wall 14, usually a minimum of one foot above the cold joint 21, which joint 21, is between the vertical wall 44, and the horizontal slab 13. The waterproofing is then extended up the vertical wall 44 and once installed, the concrete or shotcrete 15, is then cast or formed against the installed inventive membrane 23. The concrete wall 15, or concrete floor 13, that is formed over the inventive sheet membrane 23, is such that the exposed side of the concrete wall 15, or floor 13, forms the interior wall 40, or the exterior wall 40, or interior floor 40, or exterior floor 40, or a ceiling 40, (not shown), of the structure 54, or building 54. The concrete slab 13, 15, or barrier 13, 15, for the foundation of the structure 54, or floor 13, or wall 15, or building 54, is preferably a concrete or shotcrete slab or floor 13, and/or a concrete or shotcrete wall 15. The inventive membrane waterproofing system 23, prevents the water 48, or moisture 48, or hydrostatic pressure 48, from penetrating into the concrete/shotcrete floor 13 or concrete/shotcrete wall 15, from around a water table 48, or moisture 48, or hydrostatic pressure 48, thus keeping the floor surface 42, or the wall surface 44, or ceiling (not shown) completely dry, even though the area 50, around the structure 54, has water 48, or moisture 48, or hydrostatic pressure 48. The inventive membrane waterproofing system 23, comprises essentially of at least one inventive sheet membrane 23, which allows for a waterproofing of the area or regions that needs waterproofing or moisture proofing. For some applications, one could also provide the floor 13, wall 15, joining location with at least one water-stop 38, such as, for example, an Aussie swell water-stop 38.

FIG. 11, illustrates an eleventh embodiment of the inventive below grade, blind side, waterproofing sheet membrane with adhesive and quartzeral granular particle layer to fully bond to concrete/shotcrete 133. The structure of FIG. 11, is similar to the structure of FIG. 10, except that a concrete or a shotcrete retaining wall 27, has been installed instead of a wood lagging 17, between the retained earth 56, and the optional insulation board 18, or the drain board 18, and the inventive sheet waterproofing membrane 23. For some applications, the concrete or a shotcrete retaining wall 27, 15, could contain at least one metal wire mesh, which is embedded within the shotcrete/concrete 27, 15. The concrete or a shotcrete retaining wall 27, 15, can also be reinforced, using at least one reinforcing means 47, such as, for example, steel rods 47, steel mesh 47, rebar 47, fibers 47, wire mesh 47, and combinations thereof, to name a few. For some applications the sprayed concrete 13, 15, or shotcrete 13, 15, is typically reinforced by conventional securing means 47, such as, for example, steel rods 47, steel mesh 47, fibers 47, and combinations thereof, or, for example, a rebar cage 47.

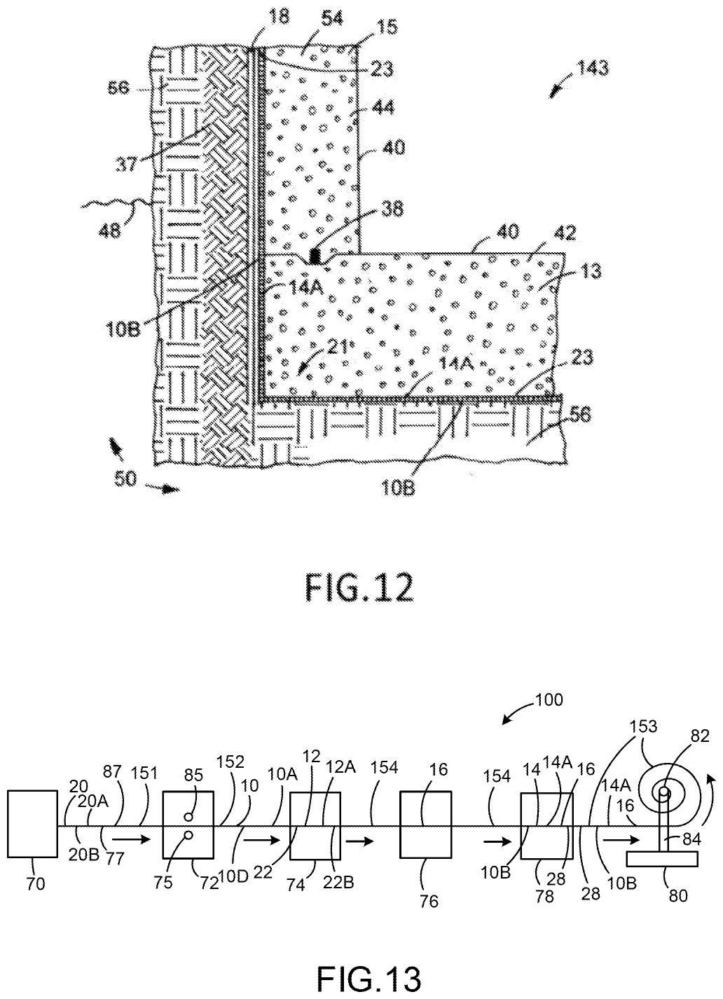

FIG. 12, illustrates a twelfth embodiment of the inventive below grade, blind side, waterproofing sheet membrane with adhesive and quartzeral granular particle layer to fully bond to concrete/shotcrete 143. The structure of FIG. 12, is similar to the structure of FIG. 10, except that another soil retention system 37, is being shown instead of a wood lagging 17, between the retained earth 56, and the optional insulation board 18, or the drain board 18, and the inventive sheet waterproofing membrane 23. The other soil retention system 37, could be any of the other typical soil retention systems 37, such as, for example, lagging retention systems, soil/cement retention systems, shot-crete retention systems, concrete retention systems, using shot-crete or concrete to create thin temporary walls retention systems, plywood retention systems, pylons retention systems, caissons retention systems, sheet-metal piles retention systems, diaphragm wall retention systems, and combinations thereof, to name a few. For some applications, such as, for example, a blind side wall 15, a soil retention system 37, may be needed to be installed, such as, for example, using wood lagging 37, a soil cement 37, a metal wire mesh embedded in concrete 37, to name a few. It should be appreciated that a soil retention system 37, helps in holding back the compacted earth or dirt 56, from coming down due to, for example, gravity. The soil retention system 37, also helps in creating a substantially uniform vertical wall surface 44.

FIG. 13, illustrates a thirteenth embodiment of the inventive below grade, blind side, waterproofing sheet membrane with adhesive and quartzeral granular particle layer to fully bond to concrete/shotcrete 100. A manufacturing machine 70, is used to un-spool a raw sheet 151, (that was made on a separate machine or at a different location) having a first or top or upper surface 87, and a second or bottom or lower surface 77, comprising of at least one sheet membrane or layer 20, having a first or top or upper surface 20A, and a second or bottom or lower surface 20B. The raw sheet 151, is then passed onto at least one charging station 72, where an electrical operation is performed on the raw sheet 151. Typically, the charging station 72, has at least one ground wire or roller 85, on one side of the raw sheet 151, such as, on the top side 87, and at least one high voltage wire 75, on the opposite side, such as, on the bottom side 77, however, for some applications the positioning of the at least one ground wire or roller 85, and at least one high voltage wire 75, could easily be reversed, that is one could be above the raw sheet 20, 151, and the other below the raw sheet 20, 151. The charging station 72, subjects one or both sides of the raw sheet 151, to high voltage so as to change the characteristics of the at least one sheet membrane or layer 20, into a sheet membrane or layer 10, having a first or top or upper surface 10A, and a second or bottom or lower surface 10B, and this process converts the raw sheet 151, into a processed or charged sheet 152. The charged sheet 152, is then moved to at least one adhesive station 74, where at least one layer of a first adhesive 12, is applied on the top or upper surface 10A, so as to form at least one first adhesive layer 12, having a first or top or upper surface 12A, and a second or bottom or lower surface 12B, where the lower surface 12B, is in secure and direct contact with the upper surface 10A, of the sheet membrane 10, and forming an adhesive formed layer 154. For some applications one could also have a process of applying at least one second adhesive 22, at the adhesive station 74 or at a separate adhesive station 74. The second adhesive 22, is applied on the bottom or lower surface 10B, so as to form at least one second adhesive layer 22, having a first or top or upper surface 22A, and a second or bottom or lower surface 22B, where the upper surface 22A, is in secure and direct contact with the lower surface 10B, of the sheet membrane 10, and forming an adhesive formed layer 154. For some applications the second adhesive layer 22, is preferably formed along an edge 10C, of the sheet membrane 10. For some applications the sheet membrane 10, having at least one layer of at least one adhesive 12, then moves to an edging station 76, where at least one edge release layer or film 16, is formed along at least one edge of the sheet membrane 10. The width of the at least one edge release layer or film 16, is between about 10 mm to about 70 mm, and preferably between about 10 mm to about 40 mm, and more preferably about 20 mm. The adhesive formed layer 154, having the edge release layer 16, is then moved to at least one sanding or particle application station 78. It should be appreciated that the edge release film 16, is applied before the quartzeral sand layer 14, is applied. At the edging station 76, at least one layer of the edge release film 16, (preferably a strip of release film 16, which is about 30 centimeters wide) is installed or formed over the adhesive layer 12, along at least one edge of the upper surface 10A of the sheet 10, where the adhesive 12, was applied along the full width of the sheet 10. For some applications an another or a second edge release film 28, could be applied over the second layer of adhesive 22, but on the opposite side of the sheet 10. The sheet 10, is then moved to the sanding station 78. In the sanding station 78, where at least one layer of a quartzeral granular particle layer 14, is formed on top of the adhesive layer 12, having a first or top or upper surface 14A, and a second or bottom or lower surface 14B, and where the lower surface 14B, is in secure and direct contact with the upper surface 12A, of the adhesive layer 12. to form an inventive waterproofing sheet membrane with adhesive and quartzeral granular particle layer 153. The processed sheet 153, is then captured by a spool 82, of the spooling machine 80, and is rolled onto the spool 82, as a finished product or sheet 153. The spooling machine 80, typically has at least one arm 84, to hold the spool 82, as the finished product or sheet 153, is being rolled onto the spool 82. It should be appreciated that when the plastic sheet or sheet membrane or layer 20, is exposed to high electrical current 75, 85, or similar other means 75, 85, to change the characteristics of the surface 10A, 10B, of the plastic or sheet membrane or layer 10, chemically, and this allows for materials, such as, for example, adhesives 12, 22, sealants, ink, etc., to name a few, to easily, and securely bond, or adhere to the surface 10A, 10B, of the sheet membrane 10. It should be appreciated that each of the stations 72, 74, 76, 78, could be at the same location or they could be at a different location. Similarly, the first or upper or top release liner or layer 16, could be applied at the edging station 76, or at a different location. Additionally, the second or lower or bottom release liner or layer 28, could be applied at the edging station 76, or at a different location. The inventive waterproofing sheet membrane with adhesive and quartzeral granular particle layer 153, is similar to the fourth embodiment of the inventive below grade, blind side, waterproofing sheet membrane with adhesive and quartzeral granular particle layer to fully bond to concrete/shotcrete 53, as illustrated in FIG. 4. It should be appreciated that the high voltage wires 75, 85, could charge and change the chemical properties of the sheet membrane 10, along a vertical path, a horizontal path, along an edge, or along the whole sheet 10, or along a specific area or section as desired by a user or a manufacturer.

As one can see in FIG. 13, that the inventive below grade, blind side, waterproofing sheet membrane with adhesive and quartzeral granular particle layer to fully bond to concrete/shotcrete 153, has a dual release liner 16, 28, comprising of a first or top or upper release liner 16, at one end or edge or portion 12C, of the inventive waterproofing sheet membrane with adhesive and quartzeral granular particle layer 153, and a second or bottom or lower release liner 28, at the opposite end or edge or portion 10C, of the inventive waterproofing sheet membrane with adhesive and quartzeral granular particle layer 153. As stated earlier that the dual release layer 16, 28, of the processed sheet 153, allows for either or both of the release layers 16, 28, to be removed in situ, and this allows the underlying adhesive 12, 22, to adhere to the surface to which it is applied or mated or secured to, and this is especially important under water or in a damp or moist environment where no additional steps need to be taken to secure the processed sheet 153, to its mating surface, such as, for example, the retaining means 17, the drain board 18, the retaining wall 27, the soil retention system 37, to name a few.

For some applications the back side or bottom surface 10B, of the plastic sheet or sheet membrane or layer 10, could be made smooth, or have a substantially smooth surface 10B. Similarly, for some applications the plastic sheet or sheet membrane or layer 10, could be exposed to high electrical current or voltage 75, 85, or similar other means 75, 85, to change the characteristics of the surface 10A, 10B, of the plastic or sheet membrane or layer 10, chemically so that objects, such as, for example, adhesives 12, 22, sealants, ink, etc., to name a few, could easily adhere, or bond to the processed sheet membrane 10. It is preferred that the plastic or sheet membrane 10, which has been exposed to the high electrical current or voltage 75, 85, has a dyne level reading of 38 or more, or a reading of 38 dyne/cm or more. A dyne level is the measure of surface energy. The more surface energy or higher dyne level a surface has, the better an adhesive 12, 22, or a sealant will adhere to it.

The at least one layer of at least one quartzeral granular particle layer 14, can be selected from a group comprising of quartzeral, particles or grains of calcite, a form of calcium carbonate, which may be made from crushed, fine-grained marble. The crushed marble/calcite sand grains may contain a trace/minor phase comprising quartz. A coating of rutile, i.e., titanium dioxide, may be applied as a pigment coating to the quartzeral particles or grains to achieve lighter or darker colors, as desired by the user or manufacturer. For some applications one could tint or dye or color the quartzeral granules particles 14, such as, for example, the quartzeral granular particle layer 14, could be, for example, a white color, a blue color, a gray color, a light color, a dark color, and combinations thereof, to name a few.

The at least one sheet membrane 10, with at least one adhesive 12, and the at least one layer of at least one quartzeral granular particle layer 14, such as, for example, an Aussie Skin 550Q, Aussie Skin 560Q, sheet or layer, is very thick, such as, for example, Aussie Skin 550Q is about 1.2 mm thick and Aussie Skin 560Q is about 2.0 mm thick. The at least one layer of the at least one sheet membrane with adhesive, such as, for example, the Aussie Skin 550Q, Aussie Skin 560Q, sheet or layer, preferably has a thickness from say between about 20 mils, to about 240 mils. For some applications one could also use a high-density polyethylene (HDPE) sheet membrane, a thermoplastic olefin (TPO) sheet membrane, a polyvinyl chloride (PVC) sheet membrane, a blended sheet membrane, or a combination thereof, or, for example, Aussie Skin 550Q, Aussie Skin 560Q, sheet or layer 23, having different thicknesses, depending on the job requirements, and ranging, for example, from about 0.5 mm to about 2.5 mm thick, that can be secured to the exposed face of the receiving surface 42, 44, such as, for example, a foundation 13, or a wall 15.

For some applications, such as, for example, the first inventive sheet membrane 23A, has to be secured to a second inventive sheet membrane 23B, Such as shown in FIGS. 5-9, it is preferred that a steel or rubber roller 81, is rolled or passed over the lap or the joint area 31, 51, 61, several times while applying pressure to ensure proper adhesion between the first at least one inventive sheet membrane 23A, and the second at least one inventive sheet membrane 23B, that are being joined at their respective edges. For some applications, such as, for example, during cold or wet weather where a first at least one inventive sheet membrane 23A, for some reason is not adhering to a second at least one inventive sheet membrane 23B, one could optionally, and gently, use a heat gun 81, or welder 81, (such as, a Liester welder), which will help improve the adhesion between the two overlapping inventive sheet membranes 23A, and 23B.

The inventive sheet membrane 23, comprises of at least one sheet membrane 10, having at least one layer of at least one first adhesive layer 12, along with the at least one layer of at least one quartzeral granular particle layer 14, such as, for example, an Aussie Skin 550Q, Aussie Skin 560Q, inventive sheet membrane 23, is very thick, such as, for example, about 1.2 mm thick. The at least one layer of the at least one sheet membrane 10, with at least one first adhesive layer 12, having at least one layer of quartzeral granular particle layer 14, such as, for example, the Aussie Skin 550Q, Aussie Skin 560Q, inventive sheet membrane 23, preferably has a thickness from say between about 20 mils, to about 240 mils. For some applications one could also use a high-density polyethylene (HDPE) sheet membrane 10, having at least one layer of at least one first adhesive layer 12, along with the at least one layer of at least one quartzeral granular particle layer 14, such as, for example, Aussie Skin 550Q, Aussie Skin 560Q, inventive sheet membrane 23, and having different thicknesses, depending on the job requirements, and ranging, for example, from about 0.5 mm to about 2.5 mm thick, that can be secured to the exposed face of the receiving surface 42, 44, such as, for example, a foundation 13, or a wall 15.

For areas where at least one sheet membrane 10, having at least one layer of at least one first adhesive layer 12, along with the at least one layer of at least one quartzeral granular particle layer 14, such as, for example, Aussie Skin 550Q sheet or layer, Aussie Skin 560Q inventive sheet membrane 23, is being joined to another sheet membrane 10, having at least one layer of at least one first adhesive layer 12, along with the at least one layer of at least one quartzeral granular particle layer 14, such as, at a gap or seam 31, it is preferred that the area that is going to be overlapped 31, 51, 61, has clean surfaces. Before bonding the next layer of the at least one sheet membrane 10, with first adhesive layer 12, with the at least one layer of at least one quartzeral granular particle layer 14, to an existing layer, or an adjacent layer, or a second layer, of at least one sheet membrane with adhesive, one should remove the release sheet or film(s) from the factory laps. It is preferred the next or second at least one inventive sheet membrane 23, be installed and mated with the previous or already installed at least one inventive sheet membrane 23, and has, for example, a minimum of say, between about 2.0 inches to about 6.0 inches overlap 51, 61. For some applications it is preferred that at least one pressure source 81, such as, for example, a steel or rubber roller 81, is rolled or passed over the gap or seam 31, 66, as shown in FIG. 6, or the joint area 31, 51, 61, several times while applying pressure 81, to ensure proper adhesion between the first at least one inventive sheet membrane 23A, and the second at least one inventive sheet membrane 23B, that are being joined at their respective edges. For some applications, such as, for example, during cold or wet weather where a first at least one inventive sheet membrane 23A, for some reason is not adhering to a second at least one inventive sheet membrane 23B, one could optionally, and gently, use a heat gun 81, or welder 81, (such as, a Liester welder), which will help improve the adhesion between the two overlapping inventive sheet membranes or layers 23A, and 23B. It should be understood that the at least one pressure source 81, can be similarly used to secure a first inventive sheet or membrane 23, 23A, 33, 43, 53, 53A, to a second inventive sheet or membrane 23, 23B, 33, 43, 53, 53B.

The reflectivity as mentioned herein can be measured in a number of ways, such as, for example, using a Novo Shade Duo Reflectivity Meter. The Novo Shade Duo Reflectometer has 3 distinct modes of operation, each using the 0/45 geometry, which are, (a) measuring the shade of a surface on a greyscale, (b) measuring the substrate opacity/hiding power, and (c) measuring the substrate cleanliness. Once a sample is placed in the reflectivity meter, within a fraction of a second, the result is displayed in “percentage Reflectance”. For the purposes of understanding, a substantially black sample would be displayed as “0 percent Reflectance”, while a substantially bright white sample would result in a reading by the reflectivity meter as being “100 percent Reflectance”. Only shading is measured, irrespective of color, and is commonly referred to as percent whiteness or percent darkness. The first or reflective surface 14A, of the inventive sheet membrane or layer of the present invention 23, 33, 43, 53, 63, 73, 83, 93, 103, 153, has a whiteness or brightness or darkness value that is between about 30 percent reflectivity to about 80 percent reflectivity. Even though the Novo Shade Duo Reflectivity Meter is extremely accurate however, during the mass production of the at least one layer of at least one quartzeral granular particle layer 14, one should take into account the batch variances, and thus one could have a variation or standard deviation for the reflectivity percentage between each batch or at least one layer of at least one quartzeral granular particle layer 14, and another layer of at least one quartzeral granular particle layer 14.

Another Reflectivity measuring device currently in use in the market is made by Rhopoint Instruments, Ltd., and is called Model Number Novo-Shade Duo+ (Novo-Shade DuoPlus), which is a dual function 45/0 degree reflectometer. The Novo-Shade DuoPlus has many features, such as, for example it measures the Reflectivity, based on measuring the shade of a surface on a greyscale, and also allows the measuring of the substrate opacity/hiding power, and it can also measure the substrate cleanliness. And, thus one can easily use the Novo-Shade DuoPlus to check that the reflectivity of the at least one layer of at least one quartzeral granular particle layer 14A, is between about 30 percent reflectivity to about 80 percent reflectivity.

Shotcrete 13, 15, or sprayed concrete 13, 15, is concrete 13, 15, or mortar 13, 15, conveyed through a hose (not shown) and pneumatically projected at high velocity onto a receiving surface 42, 44, as a construction technique. For some applications the sprayed concrete 13, 15, or Shotcrete 13, 15, is typically reinforced by conventional securing means 47, such as, for example, steel rods, steel mesh, fibers, and combinations thereof, or, for example, a rebar cage. Shotcrete 13, 15, can be placed, and compacted at the same time, due to the force with the nozzle, and it can be sprayed onto any type or shape of receiving surface 42, 44, including vertical wall surface 44, horizontal floor surface 42, or overhead areas (not shown), such as, along a roof or ceiling, which is done in a similar manner as the application along the horizontal floor surface 42, or a vertical wall surface 44, and would be well known to a person skilled in the art.

For some applications, such as, below the water table 48, a drain board 18, may be substituted with an approved protection layer 18, as long as the approved protection layer 18, is providing sufficient protection for the inventive sheet waterproofing membrane 23, 33, 43, 53, 63, 73, 83, 93, 103, 153, installed on the building or structure 54.

As stated earlier that this invention 23, 33, 43, 53, 63, 73, 83, 93, 103, 153, can be used, such as, for example, especially in a high risk conditions, where, for example, the building 54, or floor 13, or wall 15, or structure 13, 15, 54, is going to be built in a water table 48, area 50, and/or exposed to periodic or on-going hydrostatic pressure 48.

The present invention is not limited to the embodiments described herein and the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions.

It should be further understood that throughout the specification and claims several terms have been used and they take the meanings explicitly associated herein, unless the context clearly dictates otherwise. For example, the phrase “in one embodiment” as used herein does not necessarily refer to the same embodiment, though it may. Additionally, the phrase “in another embodiment” as used herein does not necessarily refer to a different embodiment, although it may. Thus, various embodiments of the invention may be readily combined, without departing from the scope or spirit of the invention.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A method of making a below grade, blind side, waterproofing sheet membrane with adhesive and quartzeral granular particle layer to fully bond to concrete/shotcrete, comprising the steps of:
(a) forming a sheet having a first surface and a second surface;
(b) moving said sheet to at least one charging station, and applying a charge to said first surface and said second surface of said sheet using at least one ground wire along said first surface of said sheet, and at least one high voltage wire along said second surface of said sheet to form a charged sheet;
(c) moving said charged sheet to at least one adhesive station, and applying at least one first adhesive layer along said first surface of said sheet, and applying at least one second adhesive layer along at least a portion of said second surface of said sheet, to form a sheet with at least one adhesive layer;
(d) moving said sheet with at least one adhesive layer to at least one particle application station, and applying at least one layer of at least one quartzeral granular particle layer along at least a portion of said at least one first adhesive layer, to form a waterproofing sheet membrane having at least one adhesive layer, and having at least one quartzeral granular particle layer.

2. The method of making a below grade, blind side, waterproofing sheet membrane with adhesive and quartzeral granular particle layer to fully bond to concrete/shotcrete of claim 1, comprising the step of:
(e) applying at least one first release liner along an edge of said at least one first adhesive layer to cover an exposed surface of said at least one first adhesive layer.

3. The method of making a below grade, blind side, waterproofing sheet membrane with adhesive and quartzeral granular particle layer to fully bond to concrete/shotcrete of claim 1, comprising the step of:
(f) applying at least one second release liner along an edge of said at least one second adhesive layer to cover an exposed surface of said at least one second adhesive layer.

4. The method of making a below grade, blind side, waterproofing sheet membrane with adhesive and quartzeral granular particle layer to fully bond to concrete/shotcrete of claim 1, wherein reflectivity of said at least one quartzeral granular particle layer is preferably between about 30 percent reflectivity, to about 80 percent reflectivity.

5. The method of making a below grade, blind side, waterproofing sheet membrane with adhesive and quartzeral granular particle layer to fully bond to concrete/shotcrete of claim 1, wherein reflectivity of said at least one quartzeral granular particle layer is preferably between about 50 percent reflectivity, to about 70 percent reflectivity.

6. The method of making a below grade, blind side, waterproofing sheet membrane with adhesive and quartzeral granular particle layer to fully bond to concrete/shotcrete of claim 1, wherein said at least one layer of at least one quartzeral granular particle layer is selected from a group consisting of quartzeral particles, granular particles of calcite, granular particles of calcium carbonate, crushed granular marble, fine-grained marble, and combinations thereof.

7. The method of making a below grade, blind side, waterproofing sheet membrane with adhesive and quartzeral granular particle layer to fully bond to concrete/shotcrete of claim 1, wherein said sheet is formed using a material selected from a group consisting a high-density polyethylene (HDPE) material, a thermoplastic olefin (TPO) material, a polyvinyl chloride (PVC) material, a blended material, and combination thereof.

8. The method of making a below grade, blind side, waterproofing sheet membrane with adhesive and quartzeral granular particle layer to fully bond to concrete/shotcrete of claim 1, wherein said sheet is formed using a material selected from a group consisting a high-density polyethylene (HDPE) material, a thermoplastic olefin (TPO) material, a polyvinyl chloride (PVC) material, a blended material, and combination thereof, and wherein thickness of said at least one sheet is preferably between about 1.0 mm and about 2.5 mm.

9. The method of making a below grade, blind side, waterproofing sheet membrane with adhesive and quartzeral granular particle layer to fully bond to concrete/shotcrete of claim 1, wherein at least one first release liner is removeably secured to an edge portion of said at least one first adhesive layer, and wherein said first release liner is adjacent said at least one layer of at least one quartzeral granular particle layer.

10. The method of making a below grade, blind side, waterproofing sheet membrane with adhesive and quartzeral granular particle layer to fully bond to concrete/shotcrete of claim 1, wherein dyne level of said charged sheet is above 38 dyne/cm.

11. A below grade, blind side, waterproofing sheet membrane with adhesive and quartzeral granular particle layer to fully bond to concrete/shotcrete, comprising:
(a) at least one sheet membrane having a first membrane surface, and a second membrane surface;
(b) at least one first adhesive layer having a first adhesive surface, and a second adhesive surface, and wherein said second adhesive surface is in secure contact with at least a portion of said first membrane surface; and
(c) at least one layer of at least one quartzeral granular particle layer, having a first particle layer surface, and a second particle layer surface, and wherein said second particle layer surface is in secure contact with at least a portion of said first adhesive surface, and wherein reflectivity of said at least one layer of at least one quartzeral granular particle layer is between about 30 percent reflectivity, to about 80 percent reflectivity.

12. The below grade, blind side, waterproofing sheet membrane with adhesive and quartzeral granular particle layer to fully bond to concrete/shotcrete of claim 11, wherein said reflectivity is preferably between about 50 percent reflectivity, to about 70 percent reflectivity.

13. The below grade, blind side, waterproofing sheet membrane with adhesive and quartzeral granular particle layer to fully bond to concrete/shotcrete of claim 11, wherein said at least one layer of at least one quartzeral granular particle layer is selected from a group consisting of quartzeral particles, granular particles of calcite, granular particles of calcium carbonate, crushed granular marble, fine-grained marble, and combinations thereof.

14. The below grade, blind side, waterproofing sheet membrane with adhesive and quartzeral granular particle layer to fully bond to concrete/shotcrete of claim 11, wherein said second membrane surface has a distinct surface, and wherein said distinct surface is selected from a group consisting of a smooth surface, a textured surface, a light textured surface, an embossed surface, a lightly embossed surface, an undulating surface, and combinations thereof.

15. The below grade, blind side, waterproofing sheet membrane with adhesive and quartzeral granular particle layer to fully bond to concrete/shotcrete of claim 11, wherein said at least one sheet membrane is made from a material selected from a group consisting a high-density polyethylene (HDPE) material, a thermoplastic olefin (TPO) material, a polyvinyl chloride (PVC) material, a blended material, and combination thereof.

16. The below grade, blind side, waterproofing sheet membrane with adhesive and quartzeral granular particle layer to fully bond to concrete/shotcrete of claim 11, wherein said at least one sheet membrane is made from a material selected from a group consisting a high-density polyethylene (HDPE) material, a thermoplastic olefin (TPO) material, a polyvinyl chloride (PVC) material, a blended material, and combination thereof, and wherein thickness of said at least one sheet membrane is preferably between about 1.0 mm and about 2.5 mm.

17. The below grade, blind side, waterproofing sheet membrane with adhesive and quartzeral granular particle layer to fully bond to concrete/shotcrete of claim 11, wherein an end portion of said first adhesive surface has removeably secured thereto at least one first protective release sheet.

18. A method of forming a below grade, blind side, waterproofing sheet membrane with adhesive and quartzeral granular particle layer to fully bond to concrete/shotcrete, comprising the steps of:
(a) taking at least one sheet membrane having a first membrane surface, and a second membrane surface;
(b) applying at least one first adhesive layer having a first adhesive surface, and a second adhesive surface, onto said at least one sheet membrane, and wherein said second adhesive surface is in secure contact with at least a portion of said first membrane surface; and
(c) applying at least one layer of at least one quartzeral granular particle layer, having a first particle layer surface, and a second particle layer surface, over at least a portion of said at least one first adhesive layer, and wherein said second particle layer surface is in secure contact with at least a portion of said first adhesive surface, and wherein reflectivity of said at least one layer of at least one quartzeral granular particle layer is between about 30 percent reflectivity, to about 80 percent reflectivity.

19. A granular material, comprising:
quartzeral, and wherein said quartzeral consists essentially of particles of calcite in a form of calcium carbonate, and made from crushed, fine-grained marble.

20. The granular material of claim 19, wherein said quartzeral contains a trace of quartz, and wherein said trace is between about 0.05 percent to about 5.0 percent.

21. The granular material of claim 19, wherein said quartzeral has at least a partial coating of titanium dioxide.

22. The granular material of claim 19, wherein said quartzeral has a partial coating of water, and wherein at least one adhesive is adhered to a surface of said water coated quartzeral.

23. The granular material of claim 19, wherein said quartzeral has a partial coating of water, and wherein at least one double-sided adhesive tape is adhered to a surface of said water coated quartzeral.

24. A waterproofing membrane assembly system for a building, comprising:
(a) at least one soil retention system having a first face and a second face, and wherein said first face faces compacted earth or soil;
(b) at least one first waterproof membrane having a first face and a second face, and wherein at least a portion of said first face of said at least one first waterproof membrane is secured to at least a portion of said second face of said at least one soil retention system, and said at least one first waterproof membrane is composed of a layer of a first material;
(c) at least one second waterproof membrane having a first face and a second face, said at least one second waterproof membrane defining at least one waterproof skin membrane comprising at least one layer of quartzeral material, and wherein at least a portion of said first face of said at least one waterproof skin membrane is secured to at least a portion of said second face of said at least one first waterproof membrane, and wherein said at least one layer of quartzeral material is on said second face of said at least one waterproof skin membrane, so as to form a dual waterproofing membrane assembly system for said building.

25. The waterproofing membrane assembly system for a building of claim 24, having at least one layer of one of concrete and shotcrete having a first face and a second face, and wherein at least a portion of said first face of said at least one layer of one of concrete and shotcrete is secured to at least a portion of said second face of said at least one waterproof skin membrane, so as to form said waterproofing membrane assembly system for said building.
